(19) United States
(12) Patent Application Publication
(10) Pub. No.: US 2011/0202682 A1
(43) Pub. Date: Aug. 18, 2011

(54) NETWORK STRUCTURE FOR DATA CENTER UNIT INTERCONNECTION

(75) Inventors: Haitao Wu, Beijing (CN); Guohan Lu, Beijing (CN); Dan Li, Beijing (CN); Chuanxiong Guo, Nanjing (CN); Yongguang Zhang, Beijing (CN)

(73) Assignee: Microsoft Corporation, Redmond, WA (US)

(21) Appl. No.: 12/705,510

(22) Filed: Feb. 12, 2010

(51) Int. Cl. G06F 15/173

(52) U.S. Cl. 709/244

(57) ABSTRACT

A number of data center units in a data center system may be directly connected with each other via switch interfaces. The data center system is server-centric and scalable by storing routing logics (e.g., inter-data center unit logic and/or inner-data center unit logic) at each server to achieve routing, load balancing, and/or fault tolerance. Switch interfaces of the data center units, thus, may be dumb devices and a centralized router for routing data among data center units may be omitted.

### BACKGROUND

Modularized data centers (MDCs), such as shipping-container based data centers, offer a way in which data centers can be built and deployed. In a MDC, thousands of servers may be interconnected via switches to form a network infrastructure, such as a typical, two-level tree structure. For example, the servers and switches may be packed into a standardized 20 or 40 foot shipping container. Since the MDC is not tied to a fixed location, organizations can place the MDC anywhere and relocate them as needs change. In addition to a high degree of mobility, a MDC may include higher system and power density, lower cooling requirements, and/or lower manufacturing costs.

In the future, MDCs may be combined to form mega-data centers. For example, a mega-data center may contain hundreds of MDC containers, with each MDC container housing thousands of servers. However, currently the use of MDCs as building blocks to construct a data center system hosting thousands—or even millions—of servers has not been feasible. One obstacle to constructing mega data centers from MDC units is that existing routing technology is insufficient to support the network structure between MDC units.

### SUMMARY

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

This document describes a network architecture that scales data center units (DCUs) to a data center system. The data center system uses switch interfaces in the data center units to build the inter-DCU structure and greatly reduces the cabling complexity among DCUs. The data center system handles inter- and inner-DCU routing intelligences at the server level of the DCUs to handle routing (e.g., load-balancing and fault-tolerance), and thus directly leverages use of commercial off-the-shelf (COTS) switches at the DCUs instead of using a centralized high-end switch or router to scale the system.

### BRIEF DESCRIPTION OF THE DRAWINGS

The detailed description is described with reference to accompanying figures. In the figures, the left-most digit(s) of a reference number identifies the figure in which the reference number first appears. The use of the same reference numbers in different figures indicates similar or identical items.

FIG. 1 shows an exemplary network architecture of a data center system.

FIG. 2 shows an exemplary 1-dimension data center system built from five data center units.

FIG. 3 shows an exemplary 2-dimension data center system built from nine data center units.

FIG. 4 shows an exemplary operation of single path routing in a data center system.

FIG. 5 shows an exemplary operation of detour routing for load balance in a data center system.

FIG. 6 shows an exemplary operation of fault tolerance routing in a data center system.

FIG. 7 shows an exemplary data packet usable in the network of FIG. 1 and operations of FIGS. 4-6.

### DETAILED DESCRIPTION

### Overview

This document describes a network structure for data center unit interconnection to scale multiple data center units to construct a data center system. In the data center system, the routing logic of data is stored in each server of the data center unit, thereby obviating the need for any high-end centralized router or switch.

Described herein are “tools” and methods to construct a data center system that is scaled up by a number of data center units or DCUs. The term “tools,” for instance, may refer to system(s), method(s), computer-readable instructions, and/or technique(s) as permitted by the context above and throughout the document. The DCUs of the data center system are interconnected via switches to form a network infrastructure.

In some examples described below, a hybrid Butterfly Cube architecture or BCube and a Modularized Data Center Cube network or MDCube are described. BCube is a network structure for inner-container server interconnection. By installing a small number of network ports (e.g., two, which is already a standard profile for existing servers in data centers) at each server, using commercial off-the-shelf or COTS switches as dumb devices, and putting routing intelligence at the server side, BCube forms a server-centric network architecture. BCube provides high network capacity and smooth performance degradation when failures increase. MDCube denotes a high performance interconnection structure to scale BCube-based containers to construct a mega-data center.

However, the tools and methods described herein can be used to scale any number, size, or type of DCU to a data center system. BCube is just an example of a DCU and MDCube is just an example of a data center system.

### Exemplary Network Architecture

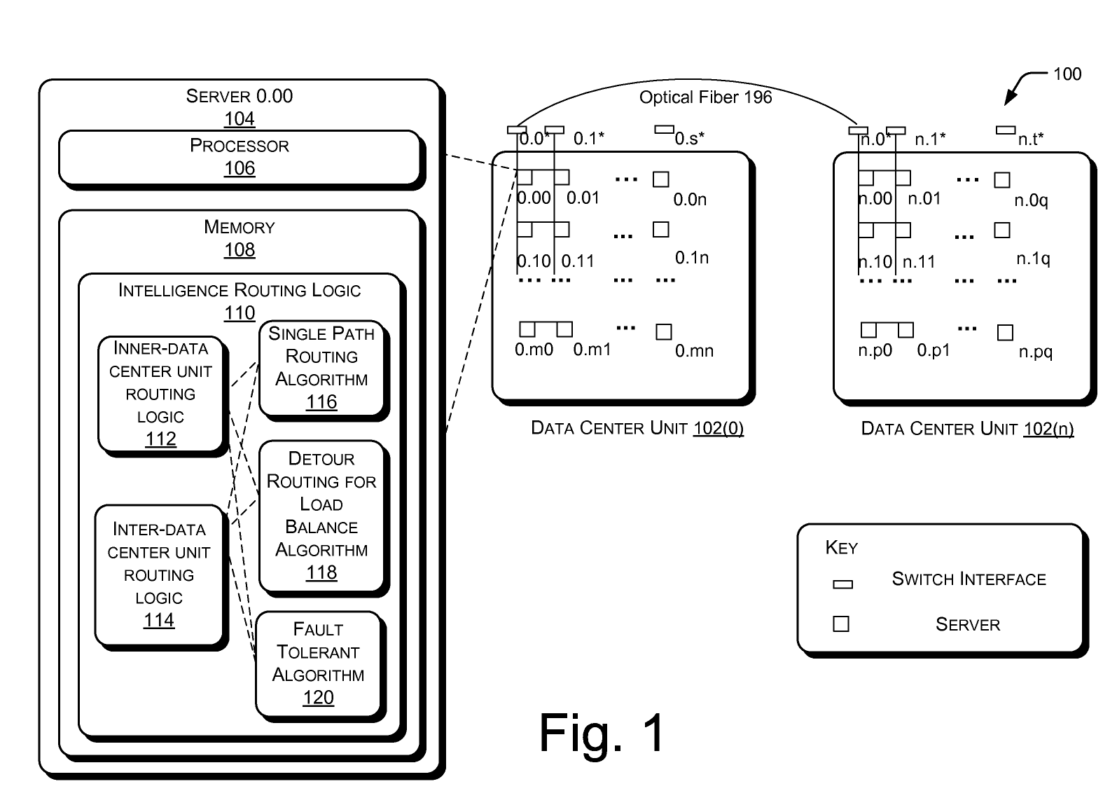

FIG. 1 illustrates an exemplary network architecture of a data center system 100. The data center system 100 provides a unique high capacity networking structure to scale a number of DCUs from DCU 102(0) to DCU 102(n), where n represents any number.

Each DCU has an ID (e.g., DCU 102(n)), where n represents an (n+1)th DCU. Each DCU (e.g., DCU 102(n)) has a number of servers (e.g., server <n.00> to server <n.pq>) and a number of switch interfaces (e.g. switch interface <n.0*> to switch interface <n.t*>), where n, p, q, and t can be any number. Each server has an ID (e.g, server <n.pq>), where n represents that the server locates at the (n+1)th DCU, and pq represents an identification number of the server at the (n+1)th DCU. Each switch interface also has an ID (e.g., switch interface <n.t*>), where n represents that the switch interface locates at the (n+1)th DCU, t* represents an identification number of the switch interface at the (n+1)th DCU.

In this example, the servers in DCU 102(n) are arranged in two dimensions and p represents an identification number of the server <n.pq> at a first dimension, and q represents an identification number of the server <n.pq> at a second dimension.

In the example of FIG. 1, the switch interfaces in DCU 102(n) are arranged into one group.

The “dimensions” refer to the layout or configuration of servers in the DCU and/or DCUs in the data center system and may be thought of conceptually as a coordinate system. However, in practice, the dimensions need not necessarily correspond to a traditional, physical coordinate system.

In some other examples, the servers can be arranged into one or more dimensions in the DCU and the switch interface can be grouped into one or more groups. The number of servers arranged into each dimension need not be the same. The number of switch interfaces grouped into each group also need not be the same.

Each of the switch interfaces (e.g. switch interface <n.0*>) can be a single high speed port of a switch or a virtual interface that is a combination of one or more high speed ports of a switch (or even multiple switches) to aggregate the bandwidth. By treating each DCU as a virtual node and the switch interfaces of a DCU as interfaces for inter-DCU connection, all the DCU-based virtual nodes form a virtual network, such as an MDCube network.

Each server (e.g., server 104 <0.00>) serves as an end host, and may also serve as an intermediate relay host for other servers when data are transmitted from a source server of a source DCU to a destination server of a destination DCU. In this example, an intelligence routing logic 110 is executable by a processor 106 and is stored on a memory 108 of the server 104 <0.00>. The intelligence routing logic 110 has a hierarchical, two-level routing algorithm for load-balancing as well as failure handling. In particular, the intelligence routing logic 110 includes both inner-DCU routing logic 112 and inter-DCU routing logic 114.

The inner-DCU routing logic 112 is to select paths among all the parallel paths in the DCU 102(0) so that load is balanced and local failures are handled. The inter-DCU routing logic 114 can use a randomized algorithm for inter-DCU load-balancing and failure handling at the DCU level when data is transmitted from the DCU 102(0) to another DCU 102(n). A loosely source-controlled routing is also described to decouple the inter- and inner-container routing. “Loosely source-controlled” means that the source server of the source DCU or the source node nominates the IDs of the intermediate DCUs on a routing path that a packet should travel to reach the destination server of the destination DCU, but the source node does not fix the exact path that the packet travel inside an intermediate DCU. That is to say, source node only determine the path at DCU level but leave freedom to inner-DCU routing to balance load inside DCU and bypass failed nodes or links.

In one example, the DCUs traversed when data are transmitted from a source server (e.g., server 104 <0.00>) of a source DCU (e.g., DCU 102(0)) to a destination server (e.g., server <n.pq>) of a destination DCU (e.g., DCU 102(n)), are selected by the source server (server <0.00>) while the path inside an intermediate or destination DCU (DCU 102(n)) is decided by an entry server of the intermediate or destination DCU, by considering current load and bypassing the failed nodes and links. The entry server is a first server at the intermediate or destination DCU (e.g., server <n.00>) receiving data transmitted from the prior DCU (e.g., DCU 102(0)).

In one example, each of the inner-DCU routing logic 112 and inter-DCU routing logic 114 can have their own single path routing algorithm 116, detour routing for load balance algorithm 118, and fault tolerant algorithm 120. In another example, the single path routing algorithm 116, detour routing for load balance algorithm 118, and fault tolerant algorithm 120 can each be divided into two parts: one for inner-DCU logic and the other for inter-DCU logic. FIG. 1 is intended to schematically illustrate both of these variations.

At the DCU level, the single path routing algorithm 116 can be fully based on the structure of the data center system 100 so that any node or DCU can be routed to any other node of the data center system 100 with only the ID of the destination server. The detour routing for load balance algorithm 118 and fault tolerant algorithm 120 can use random detour routing at the DCU level to achieve high capacity routing between DCU pairs. Such loosely controlled source routing algorithms are at the DCU level so that failures inside a DCU can be handled by each DCU instead of by the source node.

Each switch interface of one DCU is coupled directly to a switch interface of another DCU. The connection may be by wireless or cable connection. In the example of FIG. 1, a cable that connects switch interface <0.0*> of DCU 102(0) and switch interface <n.0*> of DCU 102(n) comprises an optical fiber 196. However, in other examples, cable may comprise wires, or other signal carriers.

A more specific example of switch interfaces is as follows. Commercial off-the-shelf or COTS switches provide dozens (e.g., 48) of gigabit ports and several (e.g., 4) high-speed 10 gigabit ports. The gigabit ports of a switch can be used to connect to one or more servers inside the same DCU. The multiple high-speed 10 gigabit ports of one switch or even multiple switches of the same DCU can be combined to aggregate their bandwidths to act as a switch interface to connect the DCU to another DCU. By interconnecting those bundled switch interfaces to other switch interfaces in other DCUs, the DCUs are interconnected with high bandwidth and minimal cabling cost. In an exemplary embodiment in which all of the high-speed ports of one switch are combined to provide one switch interface, the number of switches of DCU 102(0) is equal to the number of switch interfaces. When the ports of multiple switches are combined to provide one switch interface, the number of switches is different from the number of the switch interfaces.

It should be noted that each DCU need not have the same number of switch interfaces or servers. For example, data center unit 102(0) includes server <0.00> to server <0.mn> and switch interface <0.0*> to switch interface <0.s*>, where m, n, and s* represent any numbers. s* represents that the switch interface is an (s+1)th switch interface located at the DCU 102(0). mn represents an identification number of the server at the DCU 102(0), in which m represents an identification number of the server at the first dimension, and n represents an identification number of the server at the second dimension when the servers of DCU 102(0) are arranged into two dimensions as described above. As described, data center unit 102(n) includes server <n.00> to server <n.pq> and switch interfaces <n.0*> to switch interfaces <n.t*>, where p, q, or t represents any number. The numbers of m, p, n, q, s, and t need not be the same.

In one embodiment, each switch or switch interface can only “see” its directly connected servers, and those servers under its peer switch or switch interface, so that the topology of the data center system 100 is fully maintained by servers and the switches are just dumb devices. For example, switch interface <0.0*> of DCU 102(0) can only “see” switch interface <n.0*> of DCU 102(n) and the peer's directly connected servers, such as server <0.00> in DCU 102(0). With this method, the number of cables for inter-DCU connection is greatly reduced, relative to a data center system that directly scales DCU such as a BCube network to host millions of servers. Note that a MDC network system which uses high-end routers to interconnect the MDCs also has reduced interconnection cables, but with much less capacity. Also, the data center system 100 may be implemented using only cables, without the need for expensive high-end routers, to connect the DCUs. Furthermore, the capacity of the data center system 100 is readily scalable by simply connecting more DCUs. The data center system 100 described herein is not constrained by the number of ports and/or bandwidth of existing router technology.

Therefore, as illustrated in FIG. 1, by treating each DCU as a virtual node and those aggregated ports or switches of a DCU as a switch interface for inter-DCU connection, all the DCU-based virtual nodes form a virtual network. The data center system 100 can be constructed using COTS switches to connect the DCUs directly with relatively shorter lengths of fiber than would be needed to connect them all back to a central hub (as is the case with router-based DCU installations). Because the intelligence routing logic is stored on each server, a high-end switch or router that controls the routing among different DCUS is also unnecessary. The aggregate bandwidth between DCUs scales with the total uplink capacity of switches in the DCU. Moreover, the data center system 100 provides a high-degree robustness because of the large number of paths between two DCUs.

### Exemplary Data Center System Topology

In one embodiment, the data center system 100 can be designed to interconnect multiple DCUs by using high-speed (e.g., 10 gb/s) interfaces of switches in the DCUs. To support hundreds of DCUs in a mega-data center, cables, such as optical fiber 196, are used for these high-speed links.

Each switch in this example contributes its high-speed interfaces as a virtual interface for its DCU. For example, all the high-speed link interfaces of one switch are combined into one virtual switch interface <0.0*> of DCU 102(0) by port trunking: e.g., four 10 gb/s high-speed interfaces of a 48-port gigabit switch can be bundled into a virtual switch interface <0.0*> of DCU 102(0) at 40 gb/s. Thus, if each DCU is treated as a virtual node, it can have multiple virtual interfaces (the exact number is the number of switches in this example). Each switch is only aware of its directly connected servers and its directly connected peer switch as well as servers connecting to that peer. Therefore, the data center system 100 is server centric, and switches or switch interfaces may be inexpensive dumb devices.

The switch interfaces of the DCUs can be used to form a basic complete graph. Suppose the number of DCUs to be connected is M, and there is a direct link between any two DCUs, then each DCU needs M−1 switch interfaces. To be scalable when the number of DCUs grows, the virtual complete graph topology can be extended to a generalized cube by introducing dimensions.

For example, a DCU can be assigned a multiple-dimension ID, such as 3-dimension ID (x, y, z), where x, y, or z represents an identification number at each dimension. The switch interfaces of the DCU are also divided into groups according to the dimensions, serving as interfaces connecting to different dimensions. The number of groups of switch interfaces is no less than the number of the multiple dimensions, i.e., three in this example. A first group of switch interfaces of respective DCU is connected to the DCUs that have IDs only different from the respective DCU in a first dimension. A second group of switch interfaces of respective DCU is connected to the DCUs that have IDs only different from the respective DCU in a second dimension. A third group of switch interfaces of the respective DCU is connected to the DCUs that have IDs only different from the respective DCU in a third dimension. The IDs of the DCUs connected with the DCU (x, y, z) are in the form of (x, y, a), (x, b, z), or (c, y, z), where a can be any number other than z, b can by any number other than y, c can be any number other than x.

Therefore, a DCU is identified by the ID that is mapped to a multi-dimensional tuple. Each DCU connects to other neighbor DCUs with a different tuple on one dimension.

The following illustrative embodiment uses BCube as an example of a DCU and MDCube as an example of a data center system. The tools and methods can be extended to construction of any size or type of DCU.

For example, a (D+1) dimensional MDCube can be built by a number of containers as follows. M represents the number of containers to be connected. While this example is described in the context of containers, it should be understood that the configuration may be applied to systems using types of DCUs as well. M=Π_{d=0}^{D}m_{d}, where m_{d} is the number of containers on dimension d. A container data center is identified by a (D+1)-tuple cID=c_{D}c_{D-1} . . . c₀, (c_{d}ε[0, m_{d}−1], dε[0, D]). Each container houses Σ_{d=0}^{D}(m_{d}−1) switches. m_{d}−1 is the number of switches on dimension d. In MDCube, each switch is identified by its container data center ID (cid) and its switch ID (bwid) in its BCube container as follows: {cid, bwid}, where cidε[0, M−1], and where bwidε[0, Σ_{d=0}^{D}(m_{d}−1)−1]. In this example, each switch contributes one trunked interface for MDCube's interconnection so that the number of switches is equal to the number of switch interfaces. There are two types of links in MDCube: one is the normal inner-container links by which switches connect to servers in the same container, and the other is the inter-container high-speed links between switches in different containers.

An example algorithm that may be used in the construction of an effective MDCube is as follows:

```
/* D + 1 is the dimension size of MDCube;
m_{d} is the number of containers on dimension d;
*/
Build MDCube(D, m_{D}, m_{D}-₁, . . . , m₀):
  for (int d = D; d ≧ 0 d − −)
    for (int i = 0; i < m_{d} −2; i + + )
      for ( int j =i + 1;j < m_{d} −1;j + + )
        cID₁ = C_{D} . . . c_{d+1}ic_{d-1} . . . c₀;
        cID₂ = c_{D} . . . c_{d+1}jc_{d} ₋₁ . . . c₀;
        bwid₁ = j − 1 + Σ ₓ₌₀^{d-1}(mₓ − 1);
        bwid₂ = i + Σ ₓ₌₀^{d-1} (mₓ − 1);
        connect {cID₁, bwid₁} and {cID₂, bwid₂};
return;
```

There is a link on dimension d between two containers that have different identity tuples only on dimension d.

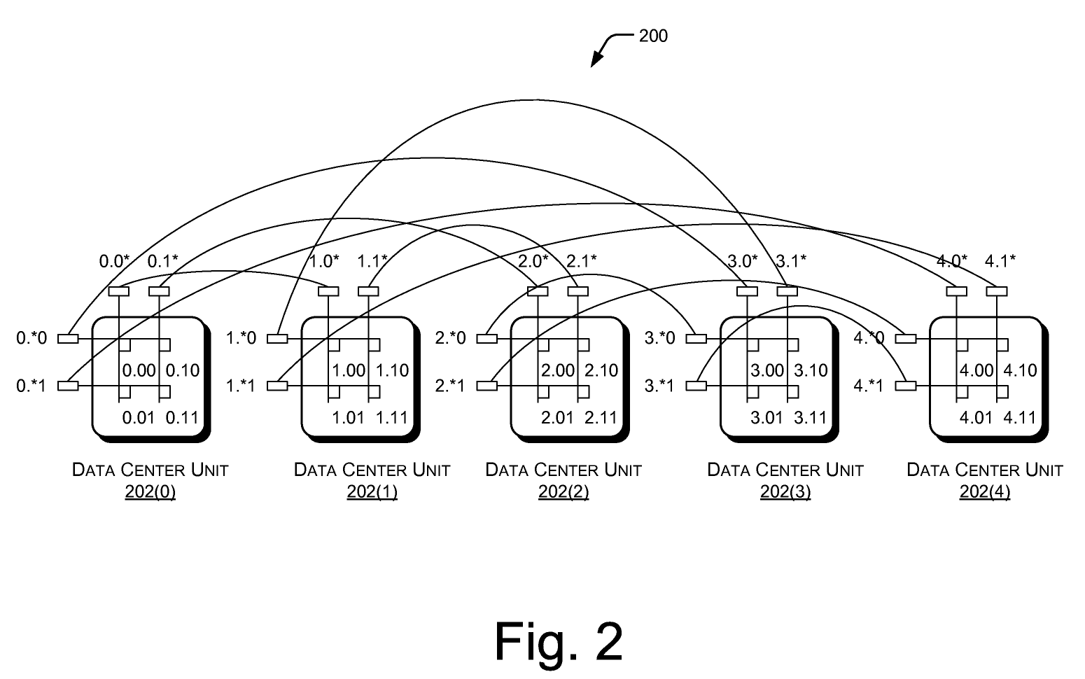

FIG. 2 shows a simplified 1−d data center system built from five DCUs according to the algorithm above. Each DCU has an ID, such as DCU 202 (0). There is only one number in the bracket of ID in this example, which means that the DCU 202 (0) only has 1-dimension ID. Each DCU (e.g., DCU 202(0)) hosts 4 servers (e.g., server <0.00>, server <0.10>, server <0.01>, and server <0.11>). Each server (e.g., server <0.00>) also has its server ID. Each switch interface (e.g., switch interface <0.0*>) also has its server ID. As there is only dimension in the data center system 200, the switch interfaces of each DCU are grouped into one group.

Each DCU (e.g., DCU 202(0)) is directly connected to the interfaces of the other four DCUs through its four switch interfaces, i.e., switch interface <0.0*>, switch interface <0.1*>, switch interface <0. *0>, and switch interface <0. *1>. In other words, each DCU is connected to the other DCUs that have the same dimension with the respective DCU. In this example, the system is arranged in one dimension so that each DCU is directly connected to all of the other DCUs in the data center system 200. FIG. 2 illustrates the topology.

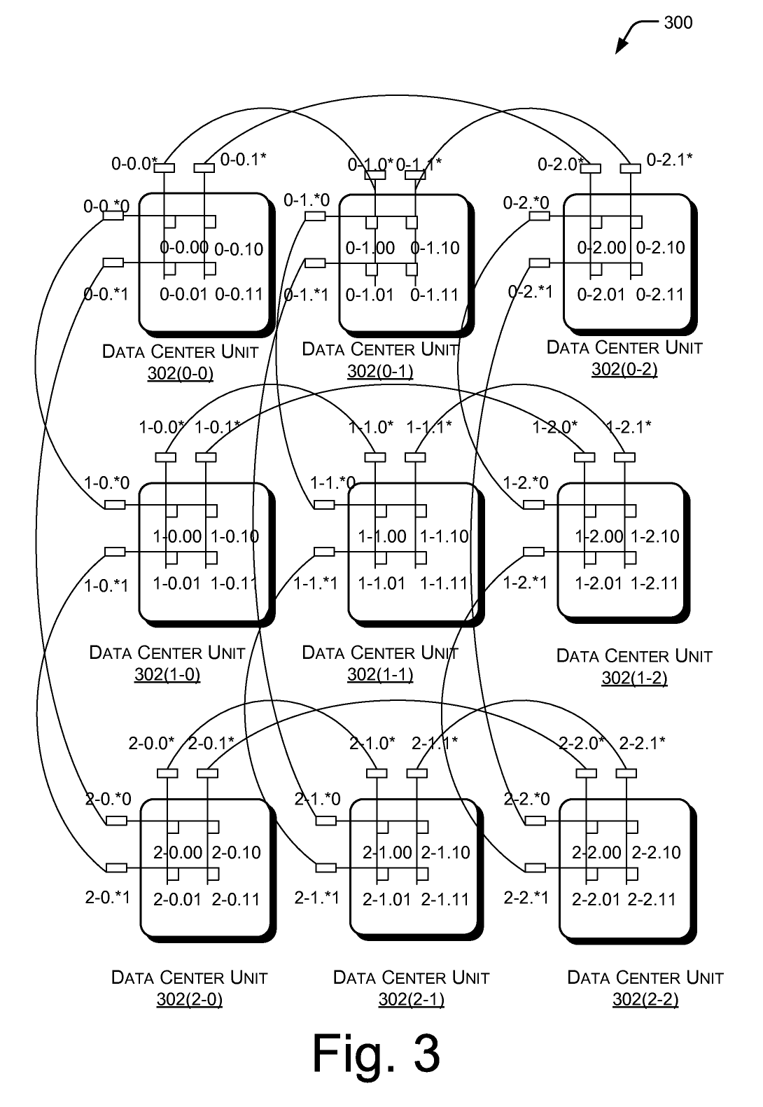

In another example, FIG. 3 shows a 2−d data center system built from nine DCUs. Each DCU has a 2-dimension ID, such as DCU 302 (2-1). A first dimension identification number of DCU 302 (2-1) is “2” and a second dimension identification number of DCU 302 (2-1) is “1”. The DCUs are arranged into two dimensions in a data center system 3000 according to the IDs. Ideally, the number of DCUs that are arranged into each dimension is closest to a root of the number of DCUs in the data center system 300, which is [symbol] =3 in this case. However, in other embodiments, the number of DCUs in each dimension may differ.

Each DCU (e.g., DCU 302(2-1)) hosts four servers (e.g., server <2-1.00>, server <2-1.10>, server <2-1.01>, and server <2-1.11>) and four switch interfaces (e.g., switch interface <2-1.0*>, switch interface <2-1.1*>, switch interface <2-1.*0>, and switch interface <2-1.*1>). The switch interfaces are grouped into groups according to the number of dimensions of the data center system 300.

In the example of FIG. 3, DCU 302(2-0), DCU 302(2-1), and DCU 302 (2-2) have IDs that are only different from each other at the second dimension and have the same first dimension identification number, i.e., “2”. DCU 302(0-1), DCU 302(1-1), and DCU 302 (2-1) have IDs that are only different from each other at the first dimension and have the same second dimension identification number, i.e., “1”. Each DCU's switch interfaces are divided into two groups according to the two dimensions in this embodiment.

In the example of FIG. 3, the first group of switch interfaces corresponds to the first dimension of the DCU and the second group of switch interfaces corresponds to the second dimension of the DCU. However, in some other examples, the first group of switch interfaces can correspond to the second dimensions of the DCU and the second group of switch interfaces can correspond to the first dimension of the DCU.

For example, switch interface <2-1.0*> and switch interface <2-1.1*> are grouped into the first group of switch interfaces of DCU 302(2-1). Switch interface <2-1.*0> and switch interface <2-1.*1> are grouped into the second group of switch interfaces of DCU 302(2-1). Switch interfaces in the first group of DCU 302(2-1) are connected to the DCUs having the same first dimension of DCU 302 (2-1), i.e., DCU 302(2-0) and DCU 302(2-2) in this example. As shown in FIG. 3, switch interface <2-1.0*> of DCU 302(2-1) is connected to switch interface <2-0.0*> of DCU 302(2-0) and switch interface <2-1.1*> of DCU 302(2-1) is connected to switch interface <2-2.1*> of DCU 302(2-2). Switch interfaces in the second group of DCU 302(2-1) are connected to the DCUs have the same second dimension of DCU 302 (2-1), i.e. DCU 302(0-1) and DCU 302(1-1). As shown in FIG. 3, switch interface <2-1.*0> of DCU 302(2-1) is connected to switch interface <0-1.*0> of DCU 302(0-1) and switch interface <2-1.*1> of 302(2-1) is connected to switch interface <1-1.*1> of DCU 302(1-1). FIG. 3 illustrates the topology and each DCU is directly connected to the other DCUs in its respective first dimension and the other DCUs in its respective second dimension. In other words, each DCU is connected to every other DCU that is only different from the respective DCU in one dimension. In the example of FIG. 3, each DCU is connected to every other DCU that has the same row or column of the DCU in FIG. 3.

As illustrated in FIG. 2, all of the five DCUs are physically arranged in a line according to the IDs of the DCUs. As illustrated in FIG. 3, all of the nine DCUs are physically arranged in a matrix according to the IDs of the DCUs. The IDs of DCUs or servers or switch interfaces in the FIG. 2 or FIG. 3 can act like coordinates that decide their physical locations in the data center system 200 or 300.

However, in other embodiments, the DCUs in either FIG. 2 or FIG. 3 (or other deployments) can be arranged in other physical locations as long as their logical connection relationships among their interfaces remain the same as shown in FIG. 2 or FIG. 3, respectively. In that case, the IDs of the DCUs, servers, and/or switch interfaces can be used to represent a unique identification and logical relationship between them, without defining the physical layout or configuration of the system. That is, an ID need to be treated like a coordinate for physical location of an object represented by the ID, and the object need not be physically placed according to the coordinate. For example, in FIG. 3, the physical location of two random DCUs, such as DCU 302(0-0) and DCU 302(1-2) can be exchanged as long as each DCU still maintains its unique interconnection relationships to other DCUs.

The construction method can provide many ways to organize a number of M DCUs. For example, when M=64, the DCUS can be arranged into 1−d (1×64), 2−d (8×8, or 2×32, etc), or 3−d (4×4×4) configurations.

### Example Selection of Dimensional Configuration

This section describes how to decide a number of dimensions and to choose a value of i.e., the number of DCUs on each dimension i. Where, as in the foregoing examples, multiple different dimensional arrangements are possible, there are two principles on how to choose the dimensional arrangement. First, the plurality of data center units should be arranged into a lowest dimension possible given the number of switch interfaces of the plurality of data center units. For example, 1−d data center system is preferred over 2−d data center system if the number of switches is enough because 1−d has higher aggregate bottleneck throughput (ABT). Second, when two or more dimensions d are used, mᵢ should be selected to be an integer value closest to [symbol] , as it requires the least number of switches so that duplication is maximized. For example, when M=64 and 2-d is used, factoring of mᵢ₌ [symbol] ₒᵣ 8. Different mᵢ or different numbers of DCUs on each dimension are also possible. However, these two principles are merely guidelines and the actual configuration may depart from these principles depending on other design considerations.

Although the techniques described herein apply to data center systems with any dimension, this document focuses on a 1−d data center system including 1−d MDCube (virtual mesh) and a 2−d data center system, including 2−d MDCube (virtual generalized hypercube) cases, since the number of servers supported in 2-d is already over 1 million. Take a MDCube constructed by BCube₁ with 48 port switches (n=48, k=1) as an example, where n is the number of ports a switch has and k denotes the level of the BCube network architecture. Each BCube container can house 48*48=2304 servers and 48*2=96 switches. In this example, the MDCube system supports up to 96+1=97 containers (0.22M servers) on 1−d, and up to 49*49=2401 containers (5.5M servers) on 2-d.

### Single Path Routing in the Data Center System

By exploring the multi-dimensional structure of the data center system at the DCU level, this application discloses a single-path routing algorithm for the data center system that may, but need not necessarily, be used with the data center system 100 of FIG. 1.

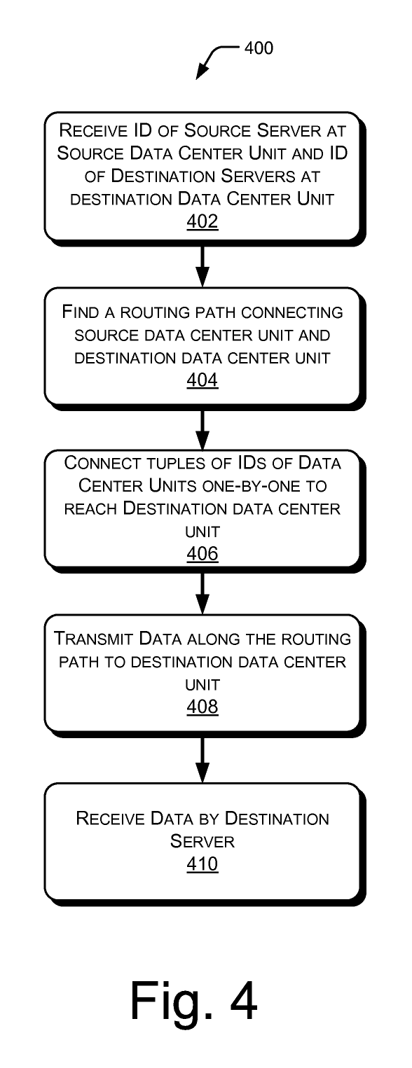

FIG. 4 provides an exemplary method of operation 400 of the single path routing algorithm in the data center system 100. However, the method 400 may alternatively be implemented in other, different systems.

Block 402 comprises receiving an ID of a source server at a source DCU and an ID of a destination server at a destination DCU.

Block 404 comprises finding a routing path connecting the source DCU and the destination DCU. One exemplary routing algorithm is the following Single Path Routing Algorithm. The Single Path Routing Algorithm may be used in connection with the MDCube as the example of the data center system and the BCube as the example of DCU and can be applied to any size or type of DCU.

```
/* Both src and dst are denoted as{cid, bsid};
  Πₓ = [πₓ, π_{x -1}, . . . , π₀] is a permutation of [0, 1, . . . x]
*/
MDCubeRouting(src, dst, II_{D}):
  c1=src; c2=c1; path = ( );
  for (i = D; i ≧ 0; i − −)
    if (the πᵢ-th entry of c2.cid and dst.cid are different)
      change πᵢ-th entry of c2.cid to that of dst.cid
      (sw₁, sw₂) = Get Link (c1.cid, c2.cid);/*switches
pair*/
      path1=BCubeRouting (c1, sw₁);
      path = path + pathl + (sw₁, sw₂):
      c1 = sw₂; c2 = c1;
    if (c2.cid = = dst.cid) /*in the same BCube*/
      path1 = BCubeRouting (c2, dst);
      path = path + path1;
```

Block 406 comprises connecting tuples of IDs of DCUs one-by-one to reach the Destination DCU.

Block 408 comprises transmitting data along the routing path to the destination DCU.

Block 410 comprises receiving data by the destination server.

In a (D+1) dimensional MDCube, each server is identified by its container data center ID (cid) and its server ID (bsid) in its BCube container as follows: {cid, bsid}. “src” represents a source server of a source BCube and “dst” represents a destination server of a destination BCube.

The procedure is to correct the tuples of the container ID one-by-one to reach the destination container, and the order of such correction is controlled by a permutation Π_{D}. Function “GetLink” returns the switch pairs that directly connect the two containers using the high-speed link defined in the Construction of MDCube Algorithm as described above. For the routing between two servers or switches in the same container, the BCubeRouting algorithm is used for the inner-container routing logic.

The BCubeRouting only defines the route between servers or switches in a same container. There are a number of well-known algorithms that transmit data between servers in the same container. “path 1” represents a routing path within a respective BCube.

The MDCubeRouting, however, defines a route for switches as a path through any of its directly connected servers among different containers. “path” represents a total routing path from the source container to the destination container. This also illustrates the hierarchy of two-level routing logics, inter-DCU routing logic 112 and inner-DCU logic 114, as described with reference to FIG. 1.

The procedure described above can be easily implemented at the server side. Therefore, the routing can be carried out without the involvement of switches or a router to centralize the routing of data among DCUs.

There are two proved properties of MDCubeRouting: (1) for a (D+1)-dimensional MDCube constructed from BCubeₖ, the path length in MDCubeRouting between any two servers is at most h=4k+3+D(2k+3); and (2) there are (k+1) parallel paths between any two servers in an MDCube built from BCubeₖs (by assuming the high-speed links between containers provide higher bandwidth than (k+1) normal speed link).

### Detour Routing for Load Balance in the Data Center System

The single path routing algorithm described above explores the hierarchical and dimensional properties of data center systems. It works well for the balanced all-to-all communication pattern. However, it may allocate bandwidth inefficiently when facing bursty traffic patterns, since it tends to only choose the shortest path at the container level. Take 1−d MDCube (virtual mesh) as example, suppose there is a need to backup all files from container A to container B, since the direct link A->B is always selected, it may result in bottleneck even if other longer paths like A->C->B through detour routing are idle. Moreover, MDCubeRouting is not fault tolerant when the selected inter-container link breaks.

This application also describes a load-balancing and fault tolerant routing algorithm that mitigates these bandwidth inefficiencies. The detour routing for load balance algorithm is used to achieve high throughput by balancing the load among the DCUs, and the fault tolerant routing algorithm is used by handling inter- and inner-DCU routing failures at DCU level and inner-DCU level, respectively.

To leverage the rich connectivity between DCUs in the data center system, a detour routing for load balance algorithm is described below. The idea of the detour routing for load balance algorithm is to initiate the routing by a random, DCU-level jump to a neighboring DCU, then perform the single path routing algorithm as shown above by correcting the first random jump at the final Block.

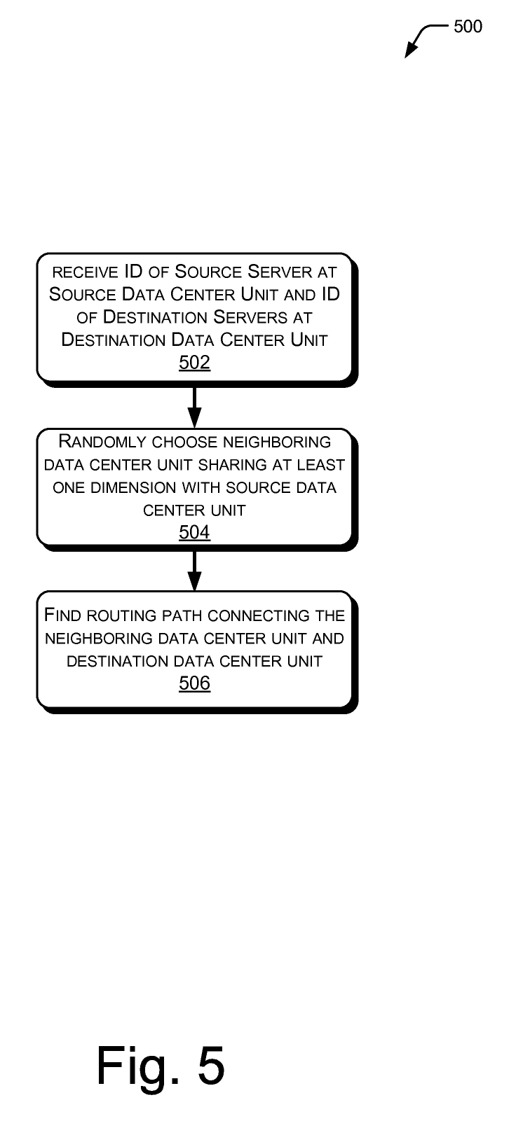

FIG. 5 provides an exemplary operation 500 of the detour routing algorithm in the data center system.

Block 502 comprises receiving ID of a source server at a source DCU and ID of a destination server at a destination DCU.

Block 504 comprises randomly choosing a neighboring DCU sharing at least one dimension with the source DCU. One example of such detour routing algorithm is the Load Balance Algorithm in MDCube as shown below.

Block 506 comprises finding a routing path connecting the neighboring DCU and the destination DCU. Such Block can be implemented by the single path routing algorithm as described above.

The following Load Balance Algorithm in MDCube uses MDCube as the example of the data center system and the BCube as the example of DCU, and can be applied to any size or type of DCU.

```
/* Both src and dst are denoted as {cid, bsid}:
    Π_{x\i} = [πₓ₋₁, πₓ₋₂, . . . , π₀ i ] is a special permutation of
  [0,1, . . . x], where i is pushed to the last one
*/
MDCubeDetourRouting (src, dst)
  inode = src; pathl = ( );
  i= random (0, D);/*a random value in [0, D]*/;
  do
      j=random(0, mᵢ−1);
      /*mᵢ is the number of containers in dimension i*/;
  until (j ≠ πᵢ-th entry of src.cid) /*not src container itself*/
  change πᵢ-th entry of inode.cid to j;
  (sw₁, sw₂) = GetLink (src.cid, inode.cid);
  path1=BCubeRouting(src, sw₁) + (sw₁, sw₂);
  path = path1 + MDCubeRouting (sw₂, dst, Π_{D\i} );
  return path, i, j;
```

In a (D+1) dimensional MDCube, each server is identified by its containter data center ID (cid) and its server ID (bsid) in its BCube container as follows: {cid, bsid}. “src” represents a source server of a source BCube and “dst” represents a destination server of a destination BCube.

Taking a 1−d MDCube as an example, the detour routing algorithm is similar to Valiant Load Balance (VLB). However, in VLB a random node is selected for detour routing, while in this detour routing algorithm, a random container is selected from among a subset of other containers. The choice is based on MDCube topology and the goal to balance the load between containers. If simply a random node is selected, then the path from the source to it, and from it to the destination, may be unnecessarily overlapped at that container, wasting bandwidth. Similar overlap holds for multi-dimensional MDCube applications.

Another difference of this detour routing algorithm compared with VLB is that this algorithm only chooses a random jump to a neighboring container (at one dimension) instead of choosing a fully random container (at all dimensions). That is, the random jump is from a source container to a container having at most one dimension different than the source container. This is because the paths obtained from the random jump are parallel (not overlapped) on intermediate containers.

First consider a 1−d MDCube: it's a complete graph, and each path takes at most one intermediate container so that a randomly selected container results in parallel detour paths. Second consider a 2-d MDCube: a random jump on dimension i (iε[0; 1]) changes the i-th entry of container ID, and it maintains that value on later correction except the final jump to the desired destination. Thus, paths started from different jumps are parallel. For multiple dimensional MDCube, the claim still holds but it needs a different term Π_{D\i}, e.g., a sawtooth sequence (ceiled at D) one like [i+1, i+2, . . . , D−1, D, 0, 1, . . . , i]. Here a sawtooth sequence starts from any number, and increases monotonically until it reaches its ceil. After that, it restarts from 0, and increases monotonically.

Another feature of MDCubeDetourRouting is that, for a (D+1) dimensional MDCube constructed by M BCube containers, in which the i-th dimension houses mᵢ containers so that M=prod(mᵢ), in total there are (mᵢ−1) intermediate container non-overlapped paths between any source destination server pairs in different containers.

### Fault Tolerant Routing in the Data Center System

When either intermediate servers or switches are failed, the detour routing algorithm above is difficult to implement since it is the failed device information may not be known immediately. Thus, directly extending a DCU's source routing protocol to the data center system faces scalability challenge. However, it is still desirable to control which intermediate DCUs are traversed to achieve multiple parallel paths to a destination DCU for high aggregate throughput. The idea of the fault tolerating algorithm dealing with failures is similar to the inter- and intra-domain routing for the Internet, but this algorithm leverages the structure of the data center system so that the source node balances the load on candidate parallel paths at a container level, and the DCU handles failures in its servers.

As shown in FIG. 1, a hierarchical routing approach of the fault tolerating algorithm is implemented to decouple the inter- and inner-DCU routing in the data center system. In that example: (1) the source node only chooses which DCU to traverse; and (2) the path inside a DCU is maintained by the DCU itself so that failed servers or switches are bypassed without notifying the source node. However, for failures between DCUs that cannot be handled by the DCU itself, e.g., the fiber link connecting two DCUs is broken, a route error message is generated and sent back to the source node to trigger rerouting at container level using other parallel paths. The source node will choose a random intermediate DCU different from the previous one. This will guarantee that the random DCU will not overlap with the previous intermediate container.

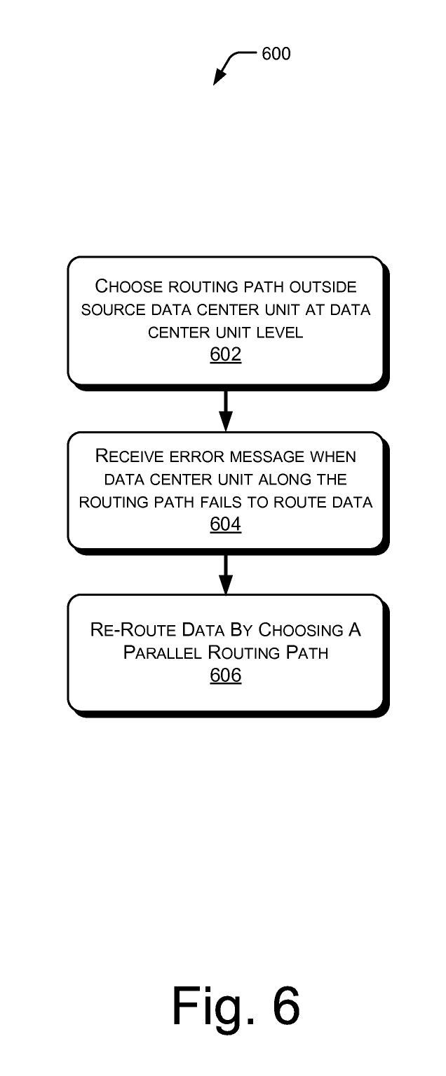

FIG. 6 provides an example of the operation of the fault tolerant routing algorithm in the data center system.

Block 602 comprises choosing a routing path outside the DCU at a DCU level.

Block 604 comprises receiving an error message when the data center unit along the routing path fails to route data.

Block 606 comprises re-routing data by choosing a parallel routing path.

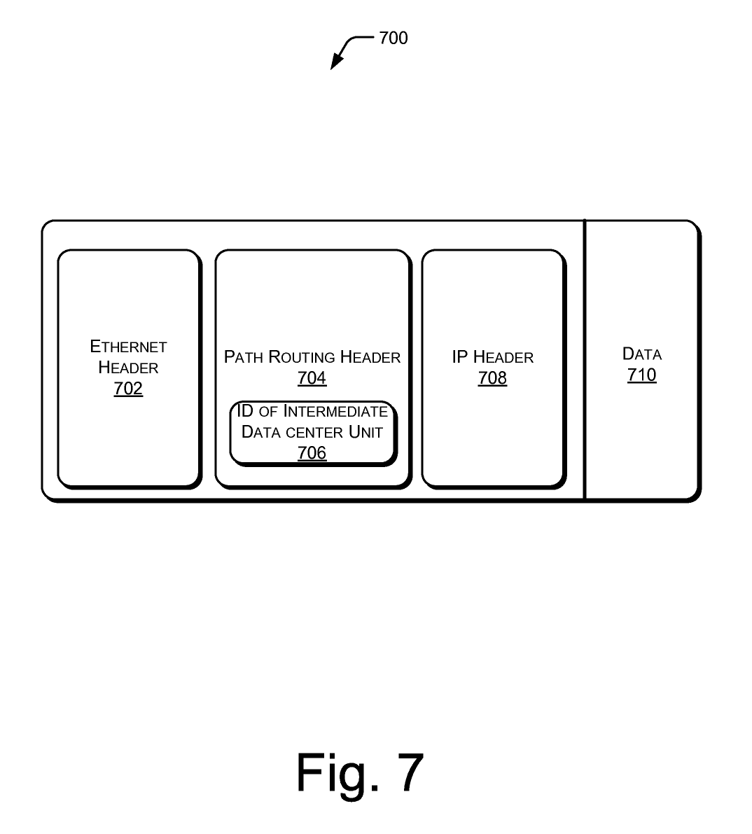

FIG. 7 shows an exemplary data packet 700 that may be transmitted over the systems 100, 200, and 300 and/or during operations 400, 500, and 600. For example, after a source node chooses its intermediate DCUs, it stores the IDs of these DCUs 706 into its path routing header 704, which, in this example, lies between Ethernet header 702 and IP header 708. The DCU IDs 706 are used to cross the routing domain. Since the inner-DCU routing logic fully controls the routing inside a DCU, a connection that traverses multiple DCUs may experience packet reordering because an intermediate DCU may route the packet using different paths inside the DCU.

In addition, there are many direct server pairs that are connected by the same inter-DCU link. Hence there exist many paths through this inter-container link. This may also result in packet reordering.

To select a fixed path from those available ones, one solution is to tag the packet with a flow_id field at the source node, and later base path selection and caching on the flow_id so that a connection is always on the same path. The first packet with a new flow_id of a source/destination pair triggers a route selection in the DCU and the path selected is cached and indexed by source/destination plus flow_id. When failure occurred and rerouting in the DCU is triggered, the new route in the DCU replaces the old entry to keep path consistent.

Note that alternatively the intermediate node can inspect the tuple (source/destination IP and port, protocol) and correct the path when a next node sends back the error message. Such flexibility can also be left to the source node.

### Exemplary Computer Environment

Server 104 may, but need not, be used to implement the techniques described herein. Server 104 is only one example of a server and is not intended to suggest any limitation as to the scope of use or functionality of the computer and network architectures.

Server 104 can be any computing device typically used in data center applications. The components of server 104 can include, but are not limited to, one or more processors or processing units, a system memory, and a system bus that couples various system components including the processor to the system memory.

The system bus represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Server 104 typically includes a variety of computer readable media. Such media can be any available media that is accessible by Server 104 and includes both volatile and non-volatile media, removable and non-removable media.

The system memory includes computer readable media in the form of volatile memory, such as random access memory (RAM), and/or non-volatile memory, such as read only memory (ROM). A basic input/output system (BIOS), containing the basic routines that help to transfer information between elements within computer, such as during start-up, is stored in ROM is illustrated. RAM typically contains data and/or program modules that are immediately accessible to and/or presently operated on by the processing unit.

Server 104 may also include other removable/non-removable, volatile/non-volatile computer storage media. By way of example, Server 104 may include a hard disk drive for reading from and writing to a non-volatile magnetic media, a magnetic disk drive for reading from and writing to a non-volatile magnetic disk (e.g., a “floppy disk”), an optical disk drive for reading from and/or writing to a non-volatile optical disk such as a CD-ROM, DVD-ROM, or other optical media.

The disk drives and their associated computer-readable media provide non-volatile storage of computer readable instructions, data structures, program modules, and other data for Server 104. Although a hard disk, a removable magnetic disk, and a removable optical disk are described, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk, magnetic disk, optical disk, ROM, and/or RAM, including by way of example, an operating system, one or more applications, other program modules, and program data. Each of such program modules and program data (or some combination thereof) may implement all or part of the resident components that support the data center system as described herein.

Server 104 can operate in a networked environment such as that shown in FIGS. 1-3 using logical connections as described herein.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on some form of computer readable media. Computer readable media can be any available media that can be accessed by a computer.

### CONCLUSION

Although embodiments for implementing a server-centric data center system are described in language specific to structural features and/or methods, it is to be understood that the subject of the appended claims is not necessarily limited to the specific features or methods described. Rather, the specific features and methods are disclosed as exemplary implementations for the data center system.

What is claimed is:

1. A system comprising:
a plurality of data center units, each data center unit comprising:
a plurality of switch interfaces, each switch interface being coupled directly to a switch interface of another data center unit; and
a plurality of servers in communication with one or more switch interfaces of the respective data center unit, each server comprising memory storing intelligence routing logic for routing data.

2. The system of claim 1, wherein the intelligence routing logic comprises a hierarchy of intelligence routing logic, the hierarchy of intelligence routing logic including:
inner-data center unit intelligence routing logic configured to route data among the plurality of servers or the plurality of switch interfaces in the respective data center unit; and
inter-data center unit intelligence routing intelligence logic configured to route data from a server in the respective data center unit to another data center unit.

3. The system of claim 1, wherein the routing intelligence logic is solely stored in each server, such that routing of data is accomplished without using a router.

4. The system of claim 1, wherein:
the plurality of data center units is arranged into one or more dimensions; and
the plurality of switch interfaces of each data center unit is grouped according to the one or more dimensions, each switch interface in a same group connecting to one or more data center units having at most one same dimension different from the respective data center unit.

5. The system of claim 4, wherein each data center unit is directly connected to the other data center units in the system through the switch interfaces.

6. The system of claim 4, wherein:
the plurality of data center units is arranged in two dimensions, a number of data center units in each dimension being chosen to be a number closest to a root of a total number of data center units in the system;
the plurality of switch interfaces of each data center unit is grouped into two groups;
a switch interface in a first group of switch interfaces of the respective data center unit is directly connected to a switch interface in a first group of switch interfaces of another data center unit having a same dimension as a first dimension of the respective data center unit; and
a switch interface in a second group of switch interfaces of the respective data center unit is directly connected to a switch interface in a second group of switch interfaces of another data center unit having a same dimension as a second dimension of the respective data center unit.

7. The system of claim 4, wherein the plurality of data center units is arranged into a lowest dimension possible given a total number of switch interfaces of all of the plurality of data center units.

8. The system of claim 1, wherein each switch interface of the data center unit is coupled directly to a switch interface of another data center unit by an optical fiber.

9. The system of claim 1, wherein each switch interface comprises an aggregate bandwidth of one or more ports of one or more switches of the data center unit.

10. The system of claim 1, wherein the intelligence routing logic further comprises a single path routing algorithm to route data from a source server of a source destination data center unit to a destination server of a destination data center unit.

11. The system of claim 1, wherein the intelligence routing logic further comprises a detour routing for load-balance algorithm to balance load among the plurality of data center units and a fault-tolerant algorithm to handle failure occurring when data is transmitted from the source server of the source destination data center unit to the destination server of the destination data center unit.

12. A computer storage medium encoded with processor-executable instructions that, when executed, direct a computing system to perform acts comprising:
storing a single path routing algorithm to route data from a source server of a source destination data center unit to a destination server of a destination data center unit, the single path routing algorithm having instructions to perform acts comprising:
transmitting data to one or more intermediate data center units on a routing path connecting the source data center unit and the destination data center unit one-by-one to reach the destination data center unit; and
controlling an order of the transmitting,
wherein the source data center unit, the one or more intermediate data center units, and the destination data center unit are arranged in one or more dimensions.

13. A computer storage medium of claim 12, wherein in an event that the source data center unit and the destination data center unit have at most one different dimension, directly transmitting data from the source data center unit to the destination data center unit.

14. A computer storage medium of claim 12, wherein in an event that the source data center unit and the destination data center unit have no same dimensions, randomly choosing an intermediate data center unit having at most one dimension different from the source data center unit to which to transmit data from the source data center unit.

15. A computer storage medium encoded with processor-executable instructions that, when executed, direct a computing system to perform acts comprising:
storing a detour routing for load balance algorithm to route data from a source server of a source data center unit to a destination server of a destination data center unit, the detour routing for load balance algorithm having instructions to perform acts comprising:
initiating a routing by a random connection to an intermediate data center unit on a routing path between the source data center unit and the destination data center unit; and
performing a single path routing after the routing by the random connection.

16. A computer storage medium of claim 15, wherein:
the source data center unit, the intermediate data center unit, and the destination data center unit are arranged in one or more dimensions;
the random connection is to an intermediate data center unit having at most one dimension different from the source data center unit.

17. A computer storage medium of claim 15, wherein the method further comprises:
storing a fault tolerating routing algorithm to route data from the source server of the source destination data center unit to the destination server of the destination data center unit, the fault tolerating algorithm having instructions to perform acts comprising:
choosing a routing path outside the source data center unit at a data center unit level;
in an event that there is a failure to route data, receiving an error message; and
re-routing data by choosing another parallel routing path.

18. A computer storage medium of claim 17, wherein the choosing a routing outside the source data center unit at a data center unit level is performed independently of a routing of data inside a respective data center unit.

19. A computer storage medium of claim 17, wherein an entry server of the intermediate data center unit includes instructions for routing data inside the intermediate data center unit.

20. A computer storage medium of claim 17, wherein the source server of the source data center unit receives an error message when the failure is incapable of being resolved within the intermediate data center unit.
